(19) United States
(12) Patent Application Publication
(10) Pub. No.: US 2010/0216371 A1
(43) Pub. Date: Aug. 26, 2010

(54) Turkey call striker

(76) Inventor: Phil Eugene Cubbedge, St. Augustine, FL (US)

Correspondence Address: Phil Eugene Cubbedge, 1165 St. R2 206, St. Augustine, FL, 32086, US

(21) Appl. No.: 12/378,806

(22) Filed: Feb. 20, 2009

(51) Int. Cl. A01M 31/00

(52) U.S. Cl. 446/418

(57) ABSTRACT

The invention provides a turkey call striker having a tip, a vibrator and a handle which may be solid or hollow with a removable stopper. Its significant new concept is a sound producing component, or vibrator, which consists of a flattened area located between the tip and the handle. Closure of the hollow handle with the stopper results in a call differing from that produced with to handle hollow open. Material of construction is preferably a hardwood such as oak or maple, but may utilize other woods, ceramics, plastics, metals or composite parts. The tip, subject to the greatest abrasion, may be of the same material as the main body of the caller, but may be a selected wear resistant material.

### BACKGROUND OF THE INVENTION

This invention provides a significantly improved turkey caller striker design for use in turkey hunting. A complete turkey caller system will usually consist of two parts, a striker and an abrasion plate. Historically turkey callers have been generally constructed from wood. The striker will generally have a handle, a vibrator section, and a tip located at the end of the vibrator section. The tip may be just the end of the vibrator section, but preferably, it is a thickened end or modified material which can stand up to abrasion against the abrasion plate. The abrasion plate is a hard material which has a slightly roughened surface. In skilled hands, rubbing the striker tip against the abrasion plate produces vibrations in the striker body resulting in sounds that mimic mating and other calls of turkeys.

Historically, turkey caller strikers have had a noise vibrator section formed by a small (about 3/16 inch diameter by four (4) inch long) wooden shaft mounted on a handle. Some strikers have an abrasion resistant tip made of metal, plastic, stone, or ceramic. This abrasion resistant tip may or may not be removable and/or replaceable. U.S. Pat. No. 2,629,968 describes a metal, rather than a ceramic abrasion plate used with a round striker. U.S. Pat. No. 4,003,159 describes an expanded sounding surface, but clearly shows the striker as a rounded shaft as is also the case for all patents listed in the references cited with one exception. U.S. Pat. No. 6,159,068 describes a flat plate striker rather than a round shaft acting against the edges of a hollow box. The hollow box of this patent is designed with one side open to provide for a sound chamber.

### SUMMARY OF THE INVENTION

This invention provides a turkey call striker having a tip, a vibrator section and a handle. The handle may be solid or hollow. Its significant new concept is a sound producing component, or vibrator, which consists of a flattened area located between the tip and the handle, combined with either a solid or hollow handle. The use of the word striker in this disclosure will always carry the meaning of “turkey caller striker.” The vibrator component is preferably located near the striker tip. In fact, one end of the flattened vibrator area can be the tip. For longevity from abrasion, material of construction is preferably hardwood such as oak, but may utilize other woods, metals, ceramics, plastics or combinations of these materials. The handle may be solid or hollow. The tip, subject to abrasion during use, is the part most likely to benefit from use of a selected wear resistant material. This tip may range in thickness from near zero to about one half inch. The flattened vibrator section is the real key to this invention. It has been found to be capable of more easily producing louder and more authentic calls than the rounded vibrators common to commercial turkey callers. The flattened vibrator is best located adjacent the striker tip with a short thickened section between the vibrator section and the tip. This thickened section is used primarily to improve resistance to the wear caused by rubbing against the abrasive plate. Absence of the thickened section will not significantly degrade caller performance, but will result in shorter caller useful service life.

An illustrative, but not limiting description of the new striker and its component sections is now given. The tip section will range in thickness from near zero at its start to about three eighths (⅜) inches at its interior junction with the vibrator section. Length of the tip is most conveniently about one quarter (¼) to one half (½) inches. Its width will generally be in the one quarter (¼) inch to three quarter (¾) inch range. The vibrator section will be about one eighth to three eights inch thick, one quarter to three quarters of an inch wide, and one to three inches long. The handle section will generally be a rounded edge square shape with sides about three quarters (¾) to one and a half (1.5) inch and range from about three (3) to eight (8) inches long. These dimensions are meant to be descriptive rather than limiting. In many cases, the entire striker will be formed from a single piece of material, but use of more than one material may offer advantages. In use, this striker will be rubbed against an abrasive plate in a manner similar to current commercial strikers in order to produce a calling sound.

The handle may be solid or contain a hollow section. The hollow handle section was initially designed to store the small items incident to use of the caller, but it was found that when the stopper was removed, the tone of the caller sound varied slightly. This new sound was attractive to some turkeys when the capped hollow section failed to get a positive response. We therefore have a double sound striker.

### BRIEF DESCRIPTION OF THE DRAWINGS

FIG. 1. is a perspective view of a common wooden commercial striker with a round vibrator rod (1), no special tip (2), and a wooden handle (3). The handle may be solid or hollow.

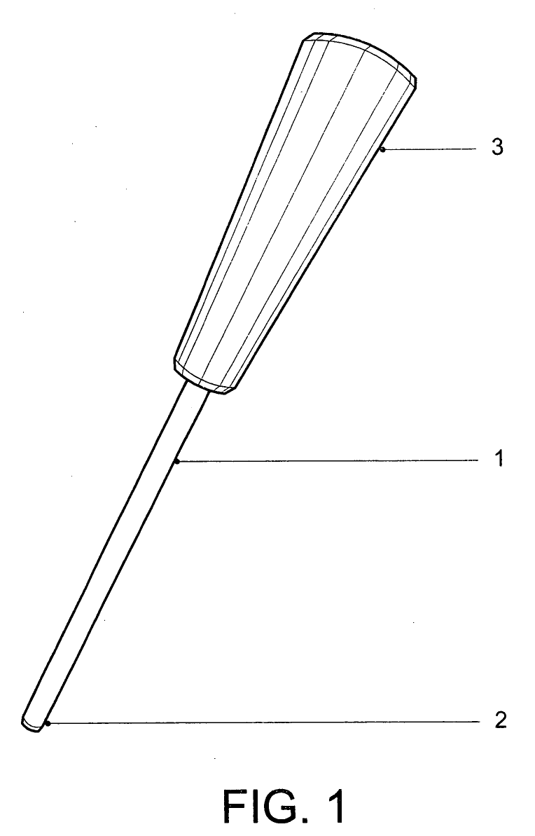

FIG. 2. shows a perspective view of a common wooden commercial striker with a tapered hollow handle (4), round vibrator rod (5), and a ceramic tip (6), which may be replaceable. In both FIGS. 1 and 2, the handle may or may not be hollow.

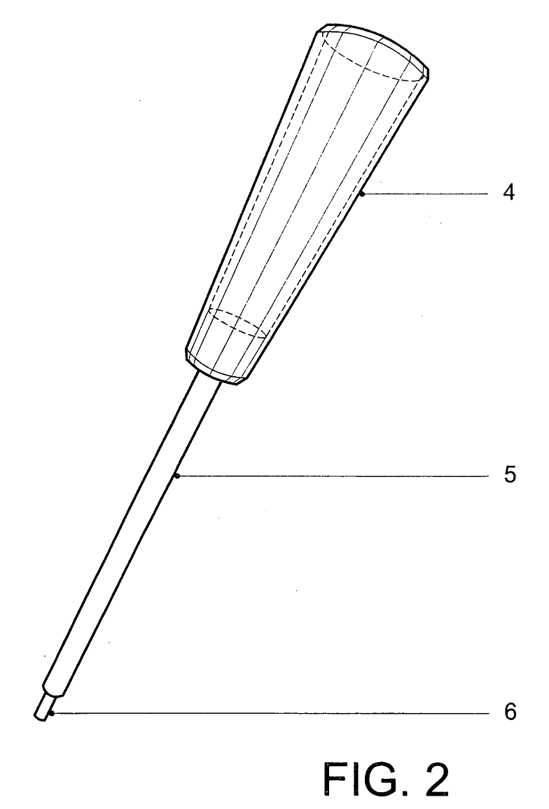

FIG. 3. shows a perspective view of the newly invented striker, portraying the newly invented flattened profiles for the tip (9), and vibrator (8), connected to a handle (7).

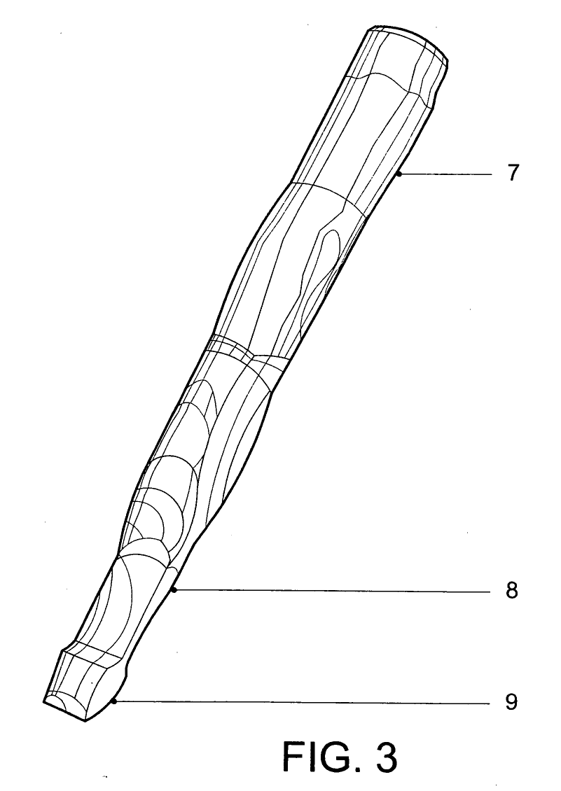

FIG. 4. shows a perspective view of the newly invented striker showing the additional feature of a hollow handle (12) and a removable stopper (13) used to store small incidentals commonly used in turkey calling. Having the hollow open or closed with the stopper varies the sound of the striker when in use.

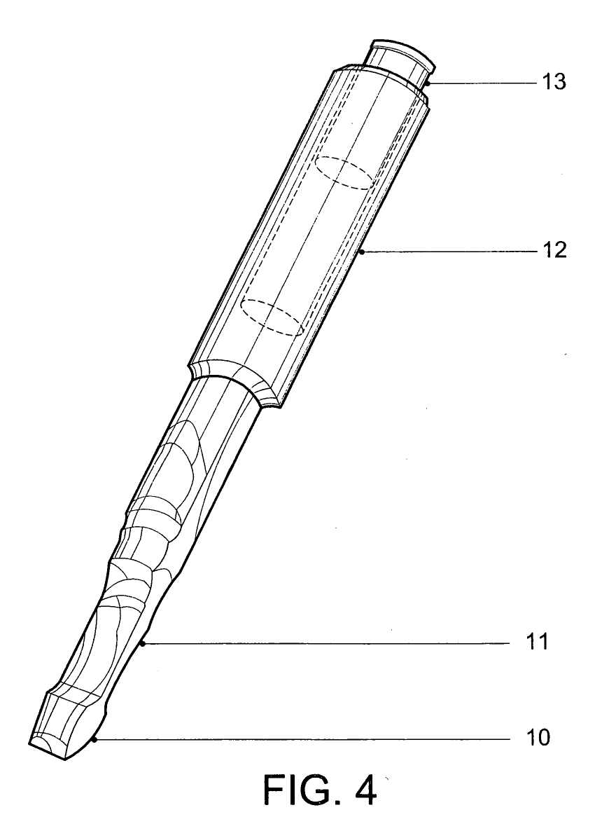

### DETAILED DESCRIPTION OF THE INVENTION

The turkey caller shall consist of three parts; a handle, vibrator and tip. One of the desirable features of this turkey caller is that many dimensions of the various functioning parts are not critical to its function. For example, the handle can be almost any shape comfortable to hold in one's hand. Handle dimensions of: a) thickness and width ranging from 0.25 to 2.0 inches, and b) length ranging from 2.0 to 10 inches. The vibrator is a flattened shape which may be from 0.05 to 0.35 inches thick, from 0.3 to 1.0 inches wide and from 0.5 to 4.0 inches long. Small to medium variations in lengths, thicknesses, and/or widths of the tip and vibrator have not been found to be critical. The tip is a small section of material at he end of the vibrator which is abraded against the abrasive plate to produce the caller sound. This tip can be a thickened section of the vibrator material, or another material attached to the end of the vibrator for this abrasive service. This is especially important in the desire for long field use of the caller. The handle shape and length can be made to accommodate easy handling and carrying in a pocket. The handle may be either solid or hollow. There are slight sound producing variations between solid, hollow handle and capped hollow handle caller designs. Practical overall enclosing dimensions for easy carrying in pockets and handling in use seem to be width and height dimensions of 0.30 to 1.5 inch, and an overall length of 4 to 9 inches. Overall widths and heights of less than 0.25 inch and lengths in excess of 16 inches appear to be impractical, even though they have been shown to marginally function. The new flat vibrator section seems to function best when it is about 0.50 inches wide, 2.0 inches long, and 0.12 inches thick. Some acceptable caller function can be obtained with dimensions from one fourth to five times these figures, but callers with size variations outside these limits are often bulky or easily broken.

In use, the flattened end of the new striker is rubbed against the abrasive plate in much the same manner as current round strikers. It has been found that the desired calling sound and sound volume can be produced with less rubbing force against the abrasive plate is reduced for the flattened vibrator than the force required by the current round strikers.

It has been found that the handle design can be used to provide more than one sound to the caller. A solid handle, an open hollow handle, and a closed hollow handle slightly change tone of the caller. The sound change from the open hollow handle to the closed hollow handle is subtle, but clearly distinct. It has been observed in the field that this change will clearly be noticeable to a turkey.

1. A turkey call striker constructed from wood, plastic, metal, or a combination of such materials, having a handle, a vibrator section, and a tip; said handle having a cross sectional area of less than 3 square inches and a length of less than 12 inches; said vibrator section having a flattened profile with a thickness between 0.075 and 0.50 inches, a width equal to at least one and one half (1.5) times its thickness, and a length equal to at least its width, said tip being either a short extension of said vibrator or modified in shape or material to resist abrasion during use, the overall length of said striker being less than 18 inches.

2. The turkey call striker of claim 1 where the overall length is less than 12 inches.

3. The turkey call striker of claim 1 where the overall length is less than 8 inches.

4. The turkey call striker of claim 1 where the handle is solid.

5. The turkey call striker of claim 1 where the handle may have a hollow section.

6. The turkey call striker of claim 2 where the handle may have a hollow section closable with a removable device.
